(19) United States
(12) Patent Application Publication
(10) Pub. No.: US 2005/0193012 A1
(43) Pub. Date: Sep. 1, 2005

(54) Private information management apparatus and method therefor

(75) Inventors: Shinako Matsuyama, Tokyo (JP); Kenzo Akagiri, Kanagawa (JP); Koji Suginuma, Tokyo (JP)

Correspondence Address: Randy J. Pritzker;Wolf, Greenfield & Sacks, P.C., 600 Atlantic Avenue, Boston, MA, 02210-2206, US

(73) Assignee: Sony Corporation, Tokyo (JP)

(21) Appl. No.: 10/965,269

(22) Filed: Oct. 14, 2004

(30) Foreign Application Priority Data
Oct. 16, 2003 (JP) JP2003-356969

(51) Int. Cl. G06F 7/00

(52) U.S. Cl. 707/104.1

(57) ABSTRACT

Disclosed is a private information management apparatus in which the information of high practical utility for a user in person may be acquired more efficiently and with higher responsiveness than is possible with a technique of keyword retrieval over the network. To this end, a private information management apparatus 1 for acquiring and storing the experience information pertinent to an event experienced by a user, and the private information input by a user, includes, as a structure for authenticating a counterpart terminal, with which the user is to exchange the experience information and the private information, an authentication key generating unit 59 for generating an authentication key for authenticating the terminal for which the information is publicized, an encryption unit 60 for encrypting part of the experience information and the private information stored as the publicized information, based on the encryption key, and an authentication processing unit 61 for verifying whether or not the authentication key received from the external terminal is one from the designated terminal. In this manner, the user is able to publicize only the information the user may feel not disinclined to publicize to another user, based on the taste information stored from user to user.

### BACKGROUND OF THE INVENTION

1. Field of the Invention

This invention relates to a private information management apparatus in which the information pertinent to the event experienced by a user and the information privately required by the user are stored in a correlated fashion.

This application claims priority of Japanese Patent Application No. 2003-356969, filed on Oct. 16, 2003, the entirety of which is incorporated by reference herein.

2. Description of Related Art

Recently, with the progress in the network structure, such as the so-called Internet, and with the widespread use of a large-capacity recording medium, an environment is being created for providing or acquiring the voluminous information. In keeping up therewith, a large variety of information providing services have been proposed and, in these information providing services, various attempts are being made for handling a large quantity of the information efficiently and efficaciously.

As an example, the information providing party extracts the taste of each user as an information accepting party to feature each individual to supply the information or services best fitted to each such individual (personalization of the information provided). This technique is used in on-line services allowing for purchase of articles of commerce from a site on the Internet. By introducing the information personalization, the services which allow for purchase of books on the Internet have realized the function of presenting recommended books to a user who purchased a book, from a list of works of the author of the book purchased by the user, the function of presenting other books purchased by other users who purchased the same book as that purchased by the user, or the function of the apprising other users of the information the user feels useful for these other users.

The party accepting the information (the party browsing the information) is able to change the operating conditions or setting according to the taste of the user (customization). For example, the responsive properties of a mouse, the window coloring or the fonts can be changed.

Such a system which, by the above information personalization or customization, enables the efficient and efficacious use of the information, has already been known. As a developing phase of the personalization, such techniques as real-time profiling of the user's behavior on the network, learning the user's operating habit to provide the user with the GUI suited to the user's taste, or monitoring the user's reaction to observe the taste or the reaction of the user to the contents recommended by an agent, are currently contemplated.

As described above, the so-called push-type information furnishing, in which the information supplied by the provider is tailored to the individual user to provide a party desiring the information or services with the optimum information, becomes possible, while the party accepting the information may acquire the desired information extremely readily.

However, for tailoring the information provided to each individual (personalization), the information provider has to collect the individual-level information, by enquetes, through paper medium or Internet sites, or to collect the behavior hysteresis of the individual users (purchase hysteresis of books in the above example). Among the information providing services, employing the Internet, there is such a service consisting in collecting the fee information pertinent to a marriage ceremony, a reception hall, an English school or a variety of culture schools, or the information pertinent to the atmosphere or service contents, from those who utilized these in the past, such as by enquetes, fitting the collected results to the rules already determined, and in displaying together the matched information, that is, the information pertinent to establishments or the experience information from the user, on a display image surface, to provide a latent user with the information in determining the establishments or the service providers.

If, in these information providing services, the information is to be made available among plural users, the retrieving step in retrieving the desired information from a large quantity of the text information is simplified by having the user furnish the information, if he/she is intending to lay open his/her experience data, depending on the experience level, and by visualizing the collected experience data of the users in order for the user retrieving the information to acquire the information of high fidelity (information close to the desired information), as disclosed for example in Patent Publication 1.

On the other hand, for effectively wine-pressing the destinations of distribution of the variegated information, there is also presented the technique in which the conditions for information reception, as desired by the recipient of the information, and the conditions for information transmission, as desired by the information sender, are input, and in which the information distribution from the sender to the recipient is allowed when the two conditions are matched to each other, as disclosed for example in Patent Publication 2.

In the technique described in this Patent Publication 1, the majority of the information, collected from those who already exploited the ceremony halls and reception halls, is the text information, and hence it is difficult to recognize readily whether or not the information contents on which the user places emphasis are contained in the text information furnished. Thus, with the conventional system, a large quantity of the text information, which inherently is not needed, may have to be read, such that it may be frequently difficult to find the information needed by the user.

The majority of the techniques for tailoring the furnished information to the individual (personalization) consist in the information provider using intricate artifices to extract a user taste model. When the services desired by individual users are furnished, the service providers group together the users having the like tastes and recommend the information preferred by an individual to other members of the group, or do not recommend the information not preferred by an individual to other members of the group. For example, there is a technique termed concerted filtering. This technique, which is an analysis carried out by the data mining technique or by the statistic technique, is based on the presupposition that a set of users grouped together under a preset condition would have a common taste. However, such technique does not necessarily reflect the intricate personal taste of the user in need of the information. Moreover, the subjective feeling of the user is also hardly reflected. In addition, the scheme of recommending the taste information of a user to a group of which the user is a member tends to present the privacy problem because the user's private information is furnished to the service provider.
[Patent Publication 1] Japanese Laid-Open Patent Publication 2003-16202
[Patent Publication 2] Japanese Laid-Open Patent Publication H9-91358

### SUMMARY OF THE INVENTION

It is an object of the present invention to provide a private information management apparatus in which the information pertinent to the event experienced by the user is stored and managed so as to be read out, and in which only the information the user may feel not disinclined to publicize is publicized to other users, so that the information highly useful for the user may be taken out with higher responsiveness than with the technique of keyword retrieval over the network, and so that the desired information may be taken out efficiently from the extracted information.

In one aspect, the present invention provides a private information management apparatus comprising information acquisition means for acquiring the information pertinent to an event experienced by a user, private information adding means for adding the private information, privately required by the user, to the acquired experience information storage means, for putting the experience information and the private information into order retrievably and for storing the information so put into order therein, key generating means for generating an authentication key, data encrypting means for encrypting part of the experience information and the private information, stored in the storage means, based on an encryption key, as the publicized information, and communication controlling means for transmitting the encrypted publicized information to an external device. The communication controlling means transmits the publicized information to a designated external device and transmits the publicized information to the external device in case the authentication key received from outside has been authenticated as being one from the designated external device.

Preferably, the private information management apparatus further comprises operation inputting means for specifying the information which is stored in the storage means and which is to be publicized, and an electronic device to which the information is to be publicized. The data encrypting means encrypts the publicized information, specified by the operation inputting means, based on the encryption key.

Preferably, the information acquisition means is speech data acquisition means for acquiring external speech data, and includes speech recognition means for recognizing the utterance of a feature word from speech data acquired by the speech data recognition means. The storage means puts the result of recognition by the speech recognition means and the information added with the private information by the private information adding means into order retrievably for storage therein.

Preferably, the information acquisition means is image data acquisition means for acquiring external image data and includes image recognition means for recognizing a feature image from image data acquired by the image data acquisition means. The storage means puts the result of recognition by the speech recognition means and the information added with the private information by the private information adding means into order retrievably for storage therein.

Also preferably, the information acquisition means is sentence data acquisition means for acquiring sentence data and includes sentence recognition means for extracting feature words from the sentence data acquired by the sentence data acquisition means. The storage means puts the result of recognition by the sentence recognition means and the information added with the private information by the private information adding means into order retrievably for storage therein.

In another aspect, the present invention provides a private information management method comprising acquiring the information pertinent to an event experienced by a user, adding to the acquired experience information the private information privately required by the user, putting the experience information and the private information retrievably into order for storage, encrypting part of the experience information and the private information, based on an encryption key, as the publicized information, encrypting the encryption key by an authentication key, and transmitting the encrypted publicized information to an external device, and transmitting the publicized information to a designated external device in case the authentication key received from outside has been authenticated as being one from the designated external device.

With the private information management apparatus, according to the present invention, the experience information or the private information collected by a user may be exchanged with other user(s) authorized in advance. Thus, if no experience information or the private information conforming to the retrieving condition is stored in the terminal used by the user in person but the information conforming to the desired retrieving condition is stored in the terminal of other authorized user(s), such information may be acquired, thus assuring a wide gamut of data that may be handled. In this manner, the information highly useful for the user may be taken out with higher responsiveness than with the technique of keyword retrieval over the network, while the desired information may be taken out efficiently from the extracted information.

The present invention provides a scheme for storing the information pertinent to an event experienced by a user and the information required by the user are stored for use later. In the present concrete example, the information privately needed by a user is termed the private information. The user's private information is a mark used to depict the information the user has acquired and is desirous to use again, or the value of evaluation for the acquired information, and is entered in connection with the information pertinent to the event experienced by the user.

According to the present invention, the date and time of a user's experience, as well as the image and the speech then recorded, are stored as the information pertinent to the event experienced by the user. The additional information as entered by the user in connection with the experienced event is handled as the private information. For example, if a user has purchased a certain commodity, the information on the date/time of purchase or the position of the store where the commodity was purchased, represents the information on the experienced event, whilst the user's impression or the lesson, obtained form the experience, such as the evaluation on the site of the store, on the services rendered or on the purchased commodity, or the grounds for such evaluation, and which is entered as ‘memoranda’, represents the user's private information.

Thus, according to the present invention, the impression on the experience, or the instances of success or failure, added by marks or evaluation values, are stored, along with the information on the experienced event, for use later. If the stored information is to be utilized, it is sufficient that the user inputs the retrieving condition, in which case the information on the like past experience can be taken out if such experience was made. For example, if the user visited the same place in the past, the information, such as the date/time of such visit, and the information on the purchased commodities, is presented, along with the private information, such as the evaluation.

In the present concrete example, in which the user in person designates the information which the user does not feel disinclined to publicize for other user or users, from among the user's experience information or private information, pertinent to the event the user has experienced and collected in person, such information may be exchanged among users authorized in advance. The user may access data subject only to authentication, without the necessity of getting the permission. Thus, if no experience information or the private information conforming to the retrieving condition is stored in the terminal used by the user in person but the information conforming to the desired retrieving condition is stored in the terminal of other authorized user(s), such information may be acquired.

According to the present invention, it is sufficient if the user acquires and stores the information pertinent to the event experienced by the user, and if the information is presented later from storage means which may be retrieved by a keyword. Hence, the apparatus of the present invention may be such a one in which the storage means is present on the network. Moreover, according to the present invention, the evaluation or the way of looking at the information from a given user may be provided, so that it is possible to render a service in which the evaluation of a restaurant based on the taste or the viewpoint of celebrities or television entertainers is provided and acquired from e.g. the network.

### BRIEF DESCRIPTION OF THE DRAWINGS

FIG. 1 is a block diagram for illustrating a private information management apparatus as a preferred embodiment of the present invention.

FIG. 2 illustrates private information management employing the private information management apparatus shown as a concrete example of the present invention.

FIG. 3 illustrates the structure of the private information management apparatus.

FIG. 4 is a flowchart for illustrating information registration processing in an information registration phase in the private information management apparatus.

FIG. 5 is a flowchart for illustrating information extraction processing in an information exploitation phase in the private information management apparatus.

FIG. 6 illustrates an example of the experience information acquired in the private information management apparatus.

FIG. 7 illustrates an example of the experience information entered by the user in the private information management apparatus.

FIG. 8 is a flowchart for illustrating the authentication processing in the private information management apparatus.

FIG. 9 illustrates an example of the current information acquired in the information exploitation phase in the private information management apparatus.

FIG. 10 illustrates an example of the retrieval conditions as entered in the information exploitation phase in the private information management apparatus.

FIG. 11 illustrates an example of data used as the retrieving condition in the private information management apparatus.

FIG. 12 illustrates an example of data displayed as the retrieved result in the private information management apparatus.

FIG. 13 illustrates the authentication processing for a counterpart party of communication in the private information management apparatus.

FIG. 14 illustrates the authentication processing for a counterpart party of communication in the private information management apparatus.

FIG. 15 illustrates the authentication processing for a counterpart party of communication in the private information management apparatus.

### DESCRIPTION OF THE PREFERRED EMBODIMENTS

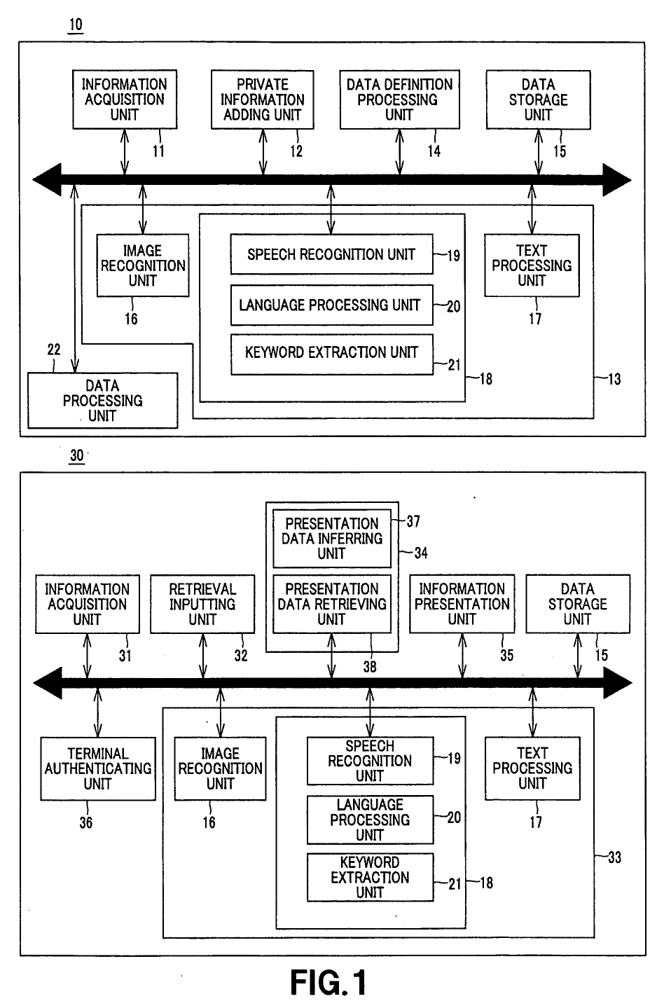

FIG. 1 shows schematics of a private information management apparatus 1, shown as a concrete example of the present invention. The private information management apparatus 1 includes an information registration unit 10 for the information registration phase pertinent to information inputting, a means for storing these information, and an information exploitation unit 30 pertinent to information outputting for the information exploitation phase exploiting the so acquired information later.

The private information management apparatus 1 includes, as the information registration unit 10, an information acquisition unit 11 for acquiring the information pertinent to an experienced event, a private information adding unit 12 for adding the private information, a data recognition processing unit 13 for recognizing the acquired information, a data definition processing unit 14 for classifying the recognized data in accordance with the predetermined definition, and a data storage unit 15 for storage of the data classified according to the definition.

The information acquisition unit 11 is a means for acquiring the information around the user, and includes a means capable of acquiring the image information, speech information, position information and time/date, such as a camera, microphone or GPS. The data recognition processing unit 13 performs the processing of extracting the specified information from e.g. the image information, speech information, position information or time/date, as acquired by a camera, microphone or GPS. The data recognition processing unit 13 includes an image recognition unit 16, a text processing unit 17 and a speech processing unit 18. The image and the text of the image data acquired from the camera is subjected to image recognition processing and text recognition processing, by the image recognition unit 16 and the text processing unit 17, to extract specified image and text data. The speech data acquired from the microphone is processed by a speech recognition unit 19 to recognize the speech. The speech information is converted into text data by a language processing unit 20, and key data is extracted from the converted text data by a keyword extraction unit 21.

The data extracted by the data recognition processing unit 13 is classified in the data definition processing unit 14 in accordance with predetermined definitions. Examples of the definitions include an image of a person, the identification information pertinent to the image of the person, such as family, brothers/sisters, spouse, place of work, friends, age groups, place of residence or nationality, the degree of density as verified from image data (low or high), sort of the building, as verified from image data (sort of the service works, as may be surmised from placards), name of the buildings (letter/character strings), time/date, weather (fine, rainy or cloudy), atmospheric temperature (high or low), humidity (high or low), wind (strong or weak), position information (latitude, longitude or altitude), closest station, common name that may be understood only by the user, evaluation value and items of evaluation (conditions of site, evaluation of the salespeople, evaluation of goods, atmosphere of store, pricing, time of supplying cooking and other conditions). The acquired data are classified based on these definitions. The data storage unit 15 holds the data classified based on the above definitions.

A data processing unit 22 generates an authentication key for authenticating a terminal, to which the information is publicized, and encrypts part of the private information and the information, pertinent to an experienced event, stored in the data storage unit 15, as the publicized information, based on a secret key, and further encrypts the secret key by a generated authentication key, by way of performing key encryption processing. The encrypted information, out of the information stored in the data storage unit 15, is sent to the terminal to which the information is publicized.

The case of exploiting the private information of the user, registered in the information registration unit 10, is hereinafter explained.

The private information management apparatus 1 includes, as the information exploitation unit 30, an information acquisition unit 31, for acquiring the current state, a retrieval inputting unit 32, supplied with the retrieving conditions, a data recognition processing unit 33 for recognizing the acquired information, a retrieving unit 34 for extracting the information conforming to the retrieving conditions or the analogous information from the data storage unit 15, and an information presenting unit 35 for presenting the extracted information to the user.

The private information management apparatus 1 also includes a terminal authenticating unit 36 for authenticating a terminal to which the user does not feel disinclined to publicize the information specified from among the user's experience information and private information which is pertinent to the event experienced by the user and which the user in person collected as described above. This terminal to which the publication may be publicized is a terminal designated in advance by the user of the private information management apparatus 1.

The information acquisition unit 31 and the data recognition processing unit 33 acquire and recognize the position information of the current site, and the other information, by a method similar to that of the information registration phase. The retrieval inputting unit 32 is supplied with the retrieving conditions by the user. The inputting methods include the speech input, text input or the image input. In case the speech is input to the retrieval inputting unit 32, the data recognition processing unit 33 extracts the keyword pertinent to the time, site and the person from the text. In case the text data is input to the retrieval inputting unit 32, the data recognition processing unit 33 extracts the keyword from the text and, in case the image data is input to the retrieval inputting unit 32, the data recognition processing unit 33 extracts the keyword from the image. Moreover, in the present concrete example, a schedule management software may be used to extract a keyword from the schedule-registered information.

The retrieving unit 34 includes a presentation data inferring unit 37, for extracting the information, analogous to the retrieving conditions, from the data storage unit 15, and a presentation data retrieving unit 38, for extracting the information matched to the retrieving condition, from the data storage unit 15. In retrieving the information from the data storage unit 15, the database management system, used in the information registration unit 10, is used for retrieval. The information extracted by the retrieving unit is presented to the user by the information presenting unit 35 by the text data, audio guide, or the image display, taken alone or in combination.

If there is no information matched to the retrieving conditions, in the data storage unit 15, and another user terminal has been specified in advance, or at a time point it has been found that there is no matching information, this terminal is accessed. Or, the information of the other user terminal, already accessed and acquired, is retrieved.

With the present private information management apparatus 1, an event experienced by a user may be stored along with the information reminiscent of the experience. The information obtained by retrieving the data storage unit 15 of the present device 1 is the information once experienced by the user, in contradistinction from the information obtained on keyword retrieval from the network, such as the Internet, thus allowing taking out the information of high utility and efficiency.

The present invention is also featured by the fact that the registrant in person exploits the information managed by the private information management apparatus 1. For this reason, the information obtained from the experience of the user, or the private information, such as impression, evaluation or lesson for the experienced event, does not have to be generalized, but may be recorded in a form that may be understood solely by the user. It is preferable that the information pertinent to the experienced event is automatically acquired by the camera, microphone or the GPS, as far as is possible, as in the example described above. The private information management apparatus 1 according to the present invention is desirable under the circumstances that, in actuality, the user feels it difficult to leave a ‘memorandum’ consciously in connection with an event experienced by the user, and is liable to lose the chance of recording the crucial information, such that, if similar chance presents itself again, it is not possible to take advantage of the previous experience.

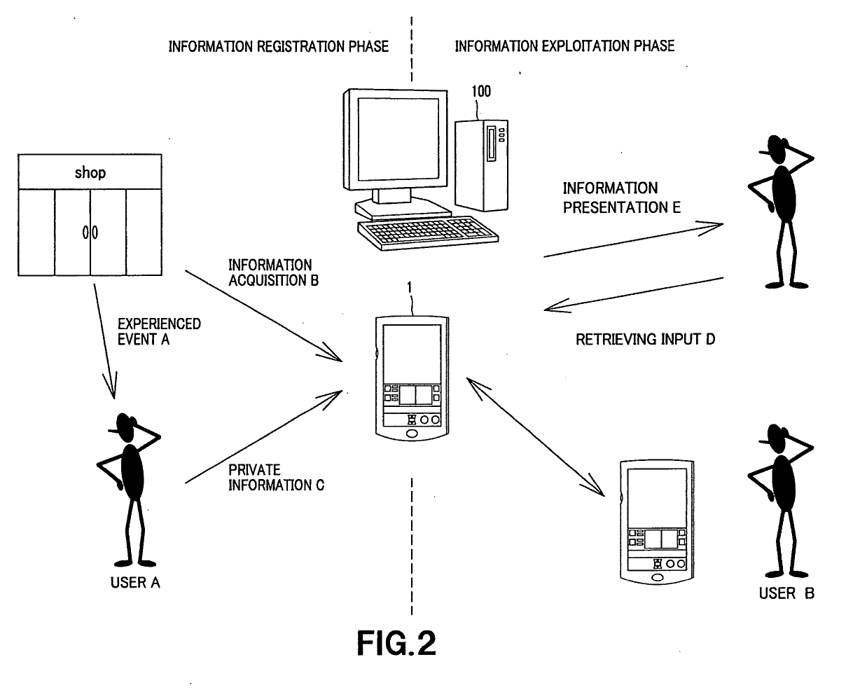

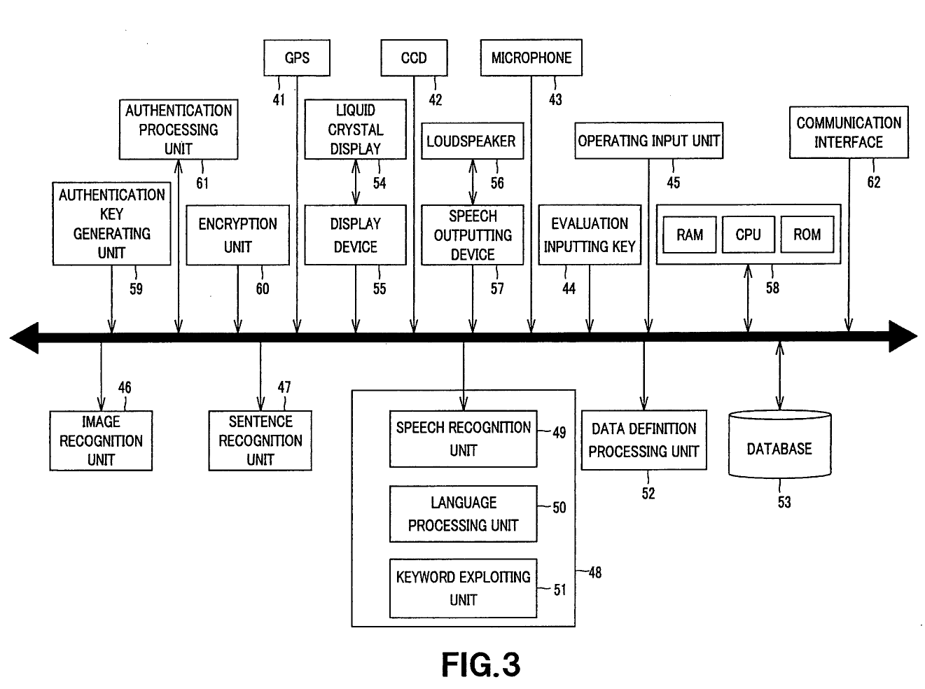

Referring to FIGS. 2 and 3, the private information management apparatus 1, as a concrete example of the present invention, is explained in detail. FIG. 2 separately shows the information registration phase and the information exploitation phase, both of which are carried out using the private information management apparatus 1. FIG. 3 shows a specified example of the private information management apparatus 1. In the present concrete example, the case of a user having a meal in a restaurant (store) is explained. Consequently, the information registration phase is the phase of registering the information of the surrounding when the user has a meal in a restaurant, and the private information at this time, while the information exploitation phase is a phase of retrieving the past information pertinent to the restaurant at the next chance from the user's own private information management apparatus 1 or another user's designated apparatus. In FIG. 2, the case of exchanging the private information and the experience information between the private information management apparatus 1 as a terminal A of the user A and a terminal of another user B having the equivalent function as a terminal B, is explained.

Since it is crucial for a user experiencing an event to carry about the private information management apparatus 1, at all times, the private information management apparatus 1 in the present concrete example is of the mobile type. Even though the private information management apparatus is of the mobile type, it may be connectable to a device corresponding to e.g. a stationary PC 100 or a server device for household use, so that the information acquired may be stored therein. In this case, it is sufficient that the data storage unit 15 of the private information management apparatus 1 is provided independently on the side of the stationary PC 100 or of the server device, so that the information will be transmitted/received wirelessly or over a wired communication interface between data storage unit and the main body unit of the private information management apparatus 1.

Referring to FIG. 3, the private information management apparatus 1 includes a GPS 41 for acquiring the position information, a CCD (charge coupled device) 42 for acquiring the information around the user, and a microphone 43. These components serve as the information acquisition unit 11 for the information registration phase and as the information acquisition unit 31 for the information exploitation phase, shown in FIG. 1. In this private information management apparatus 1, image data and voice data are automatically acquired, without operations by the user, by the CCD camera 42 and the microphone 43, at a preset time interval, or with changes in the environment around the user as a trigger. For example, detection of a large sudden sound, or detection of a keyword specified by a keyword extraction unit 51, is used as a trigger for information acquisition. In the explanation of the present concrete example, the information around the user, acquired by the information acquisition unit 11, is termed the experience information as necessary.

The private information management apparatus 1 also includes an evaluation inputting key 44, as a private information addition unit 12 for the user to add the private information, and an operating input unit 45 for a retrieval input in the information exploitation phase or for an operating input for this device. The evaluation inputting key 44 may be a simple pushbutton for inputting points corresponding to the number of times of pressing operations, or an operating input key, such as a ten-key, capable of directly inputting the evaluation values. In the present concrete example, the evaluation of ‘best’, ‘acceptable’, ‘good’, ‘bad’ and ‘worst’ is given, depending on the number of times of the pressing operations. The evaluation input from the evaluation inputting key 44 does not necessarily have to be entered simultaneously with the experience of the user. That is, the evaluation input may be made, in connection with the experienced event, at a time later than the time of the information acquisition.

The private information management apparatus 1 may be provided with a structure for acquiring the weather information, such as atmospheric temperature, humidity or weather, as a structure corresponding to the information acquisition unit 11, in addition to the above-described structure. The technique for acquiring the position information or the weather information may be exemplified by receiving the periodically distributed position information or weather information, in addition to receiving the base station information periodically transmitted from the base station, as is already realized in the field of a mobile phone. The private information management apparatus 1 may also be provided with a simple temperature or humidity sensor.

The private information management apparatus 1 includes an image recognition unit 46, a sentence recognition unit 47 and a speech recognition unit 48 for recognizing the acquired image data, sentence data and speech data, respectively. The image recognition unit 46 executes image recognition processing on the image data acquired from the CCD CAMERA 42. For example, it executes the processing of recognizing and extracting a face portion of a person. The sentence recognition unit 47 executes text recognition processing on image data acquired from the CCD camera 42. For example, it executes the processing of recognizing letter/character strings or symbols in the image, such as letters/characters in a placard, to extract the name of the building or the sign as text data. The speech recognition unit 48 includes a speech recognition processing unit 49, a language processing unit 50, and a keyword extraction unit 51. The speech recognition processing unit 40 recognizes and processes speech data acquired from the microphone 43 as speech. The language processing unit 50 converts the speech data into text data, and the keyword extraction unit 51 extracts the key word from the as-converted text data.

The private information management apparatus 1 also includes a data definition processing unit 52 for giving definitions to the data extracted by the image recognition unit 46, sentence recognition unit 47 and the speech recognition unit 48. The data definition processing unit 52 is equivalent to the data definition processing unit 14 for the information registration phase and to the retrieving unit 34 for the information exploitation phase, and classifies the extracted data in accordance with the pre-determined definitions or retrieves the information from a database 53 in accordance with the retrieving conditions.

In the database 53 of the private information management apparatus 1, there are registered, for example, image data and text data stating the information pertinent to the image data. For example, for image data of a face of a person, there are stored names of friends, addresses, sites of contact or ages in associated manner. There is also stored the information of families, brothers/sisters, spouse, people in the place of work, friends, and so forth, if any, that are pertinent to this person. The persons, sorts or names of the buildings (letter/character strings), as determined from image data, text data and speech data, extracted by the image recognition unit 46, sentence recognition unit 47 and the speech recognition unit 48, are compared to data stored in the database 53, so as to be classified and stored as new data. Among the definitions, there are, for example, the position information (latitude, longitude or altitude), time/date data, weather information (fine, rainy or cloudy), atmospheric temperature (high or low), humidity (high or low), wind (strong or weak), closest station, common names that may be understood only by the user, evaluation values and items of evaluation (conditions of site, evaluation of the salespeople, evaluation of goods, atmosphere of store, pricing, time of supplying cooking and other conditions). The acquired data are classified based on these definitions.

The data acquired and defined are model-converted, in accordance with a data model, and stored in the database 53, using a database management system (DBMS). Examples of the techniques for model conversion include the technique consisting in defining the data in a tabulated form and managing the tabulated data in accordance with the DBMS with use of a relational database (RDB), and a technique of classifying the data using the RDFs-OWL and managing the so classified data in accordance with the DBMS with use of RDFDB or XMLDB. The information pertinent to the event experienced by the user, or the private information, stored in the database 53, may be edited later, if so desired by the user.

The private information management apparatus 1 also includes, as a structure for authenticating a counterpart terminal for exchanging the experience information and the private information, an authentication key generating unit 59, for generating an authentication key for authenticating the terminal to which the information is publicized, an encryption unit 60 for encrypting part of the experience information stored in the database 53 as the publicized information based on an encryption key, and an authentication processing unit 61 for authenticating that an authentication key received from an external terminal is one from the designated terminal. The technique for encryption and authentication will be explained in detail later.

The authentication key generating unit 59 and the encryption unit 60 perform authentication processing when transmitting the own experience information and private information to another user terminal, or when receiving the experience information and the private information from another user. This authentication processing may be executed by designating a database of another user during information retrieval, or as the processing independent of the retrieving processing. When the information is exchanged with another terminal, the terminal, as a counterpart party of communication, is usually not an optional terminal, but is a terminal of a known counterpart party, so that it is sufficient that the counterpart party of communication is designated from e.g. an address book registered in the private information management apparatus 1, while it is not particularly necessary to carry out the authentication processing. However, the authentication processing improves the confidentiality of the experience information as well as the private information as the user's private information.

The private information management apparatus 1 also includes, as a structure for presenting the information to the user, an LCD (liquid crystal display) 54, as display, a display device 55, a loudspeaker 56 and a speech outputting device 57. The private information management apparatus 1 further includes a communication interface 62 for communicating with other equivalent private information management apparatuses. The above-described components are comprehensively controlled by a controller 58 including a CPU, a ROM, having stored therein e.g. a processing program, and a RAM, as a work area of the CPU.

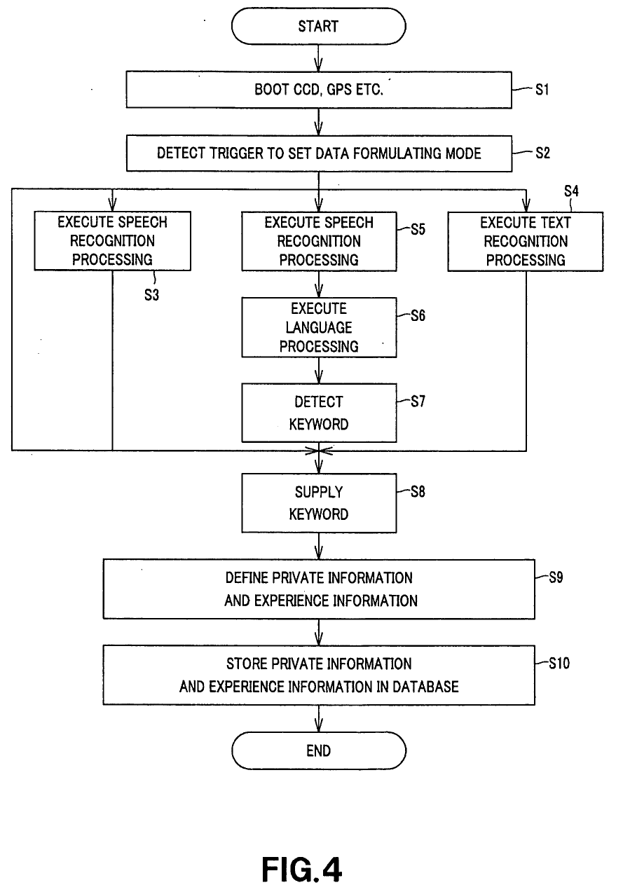

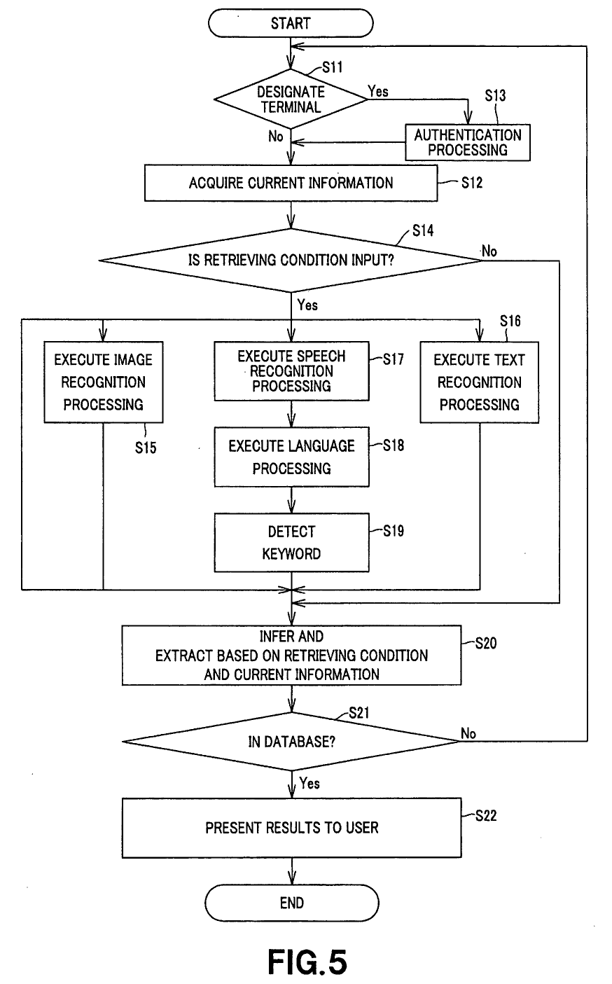

Referring to FIGS. 2 to 5, the case of registering the information pertinent to the experienced event (experience information) and the private information, by a user, with the aid of the aforementioned private information management apparatus 1, is hereinafter explained. FIGS. 4 and 5 illustrate the information registration processing for a case where a user has a meal in a restaurant (store) and the information exploitation processing of subsequent exploitation of the registered information, respectively.

First, the case where the user acquires the experience information and the private information in a restaurant 200, is explained. When the user, carrying the aforementioned private information management apparatus 1, takes a meal in the restaurant 200 (arrow A in FIG. 2), the information pertinent to the experienced event is acquired by the private information management apparatus 1 (arrow B in FIG. 2). The information acquired here is classified into the experience information and the private information. The experience information is mainly acquired automatically by the private information management apparatus 1. The private information is entered by the user (arrow C in FIG. 2). It is noted that the private information may or may not be entered simultaneously with the acquisition of the information pertinent to the experienced event.

As for the timing of the acquisition of the experience information, it is sufficient if the user sets the mode of automatically acquiring the information at a preset interval before walking into the restaurant 200. However, in a usual case, the user cannot consciously execute this mode setting operation. According to the present invention, the information pertinent to the experienced event is desirably acquired without the user becoming conscious about it, and hence the experience information is to be acquired automatically, with changes in the surrounding states as a trigger, as far as is possible. For example, if a sentence “May I help you?” is defined at the outset, as a keyword for trigger, the data formulating mode is entered when the user steps into the restaurant 200 and the private information management apparatus 1 has detected the sentence “May I help you?” operating as a trigger (steps S1 and S2 of FIG. 4).

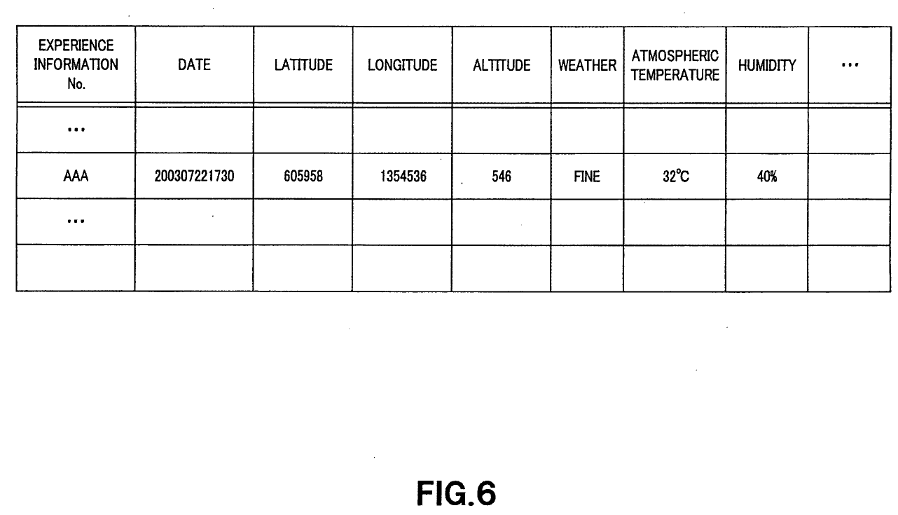

FIG. 6 shows an example of the experience information acquired at this time. If the time information acquired is 2003, Jul. 22, 17:30, it is registered as “200307221730”, while the position information is expressed as “605958, 1354536, 546) (60°59′58″ latitude, 135°45′36″ longitude and 546 m altitude). Additionally, the information on attendant states, such as the weather information, transmitted from the base station, is annexed. Moreover, if there is any fact that has become apparent from the information acquired before acquisition of the experience information, such information is also annexed. In the present concrete example, this information is that pertinent to the accompanying person(s). The time information, acquired here, may be the correct time information, contained in the GPS data, or may e.g. be “2003/07/22 night” or may be an abstract expression, such as “daytime”, “night”, “holiday” or “workday”. The position information may be a station name, a building name, a name of establishment or a common name accustomed to the user, because these names may be taken out as more intelligible and user friendly information when the user performs retrieval in the information exploitation phase.

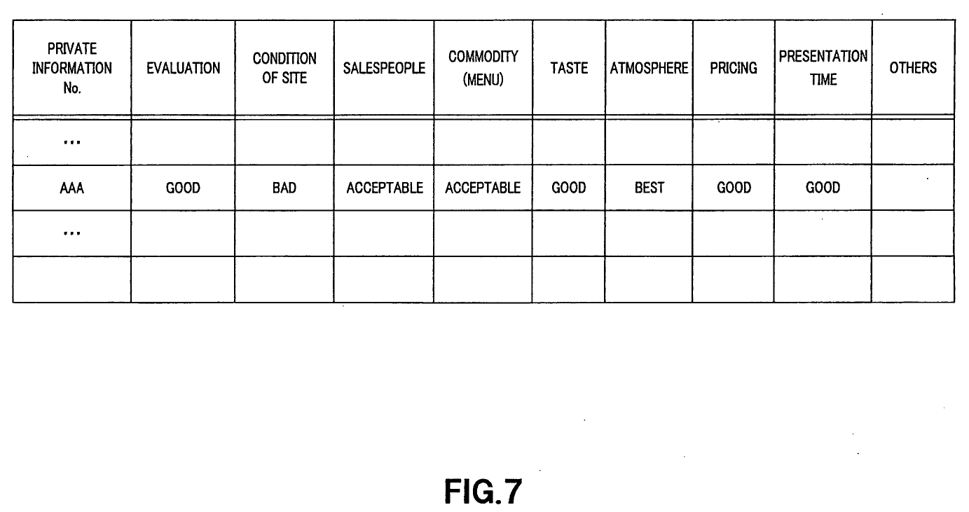

FIG. 7 shows an example of the private information as entered by the user. The private information is the overall evaluation, conditions of site, evaluation of the salespeople, evaluation of goods, atmosphere of store, pricing, time of supplying cooking and the more detailed evaluation on other conditions. Each evaluation may be recorded by the number of points actually entered by the aforementioned pushbutton type input keys.

The timing for the user to enter the private information (arrow C in FIG. 2) may be arbitrary, as described above. The private information may be added later to the acquired information. In the present concrete example, the user may be prompted to input the private information by the sound or by vibrations when the user has finished the experience in the restaurant 200, that is, when the user has moved from this restaurant to another place. There may, of course, be provided a mode which allows for acquisition of the experience information or for the inputting of the private information on the part of the user.

If, when the private information management apparatus 1 has booted the CCD camera or the GPS in a step S1, and is in a standby state, a trigger is detected, the private information management apparatus 1 in a step S2 moves to a data formulating mode, and acquires the experience information. The experience information, acquired in a step S2, is recognized and processed as from a step S3. If the experience information acquired is image data, the image recognition processing is carried out on image data acquired from the CCD camera 42 in a step S3. If the experience information acquired is the image data, and the letter/character information is contained in the image, the sentence recognition unit 47 in a step S4 executes text recognition processing on image data acquired from the CCD camera 42, and recognizes the letter/character string, in the image, such as the letters/characters of e.g. a placard, to extract the name of the building or the sign as text data. If the experience information acquired is the speech data, the speech recognition processing unit 40 in a step S5 performs speech recognition processing on the acquired speech data. Then, in a step S6, the language processing unit 50 converts the speech information into text data and, in a step S7, the keyword extraction unit 51 extracts the keyword from the text data. The GPS data, acquired by the GPS 41, such as the position data or the date/time data, and the text data, entered by the information presenting unit 35, may directly be used, and hence the private information management apparatus 1 proceeds to the next step.

In a step S8, the private information management apparatus 1 accepts the inputting of the private information from the user. At this time, the information that could not be acquired as the experience information, such as the store name or store site, is entered simultaneously by the user. However, the private information does not have to be entered at this stage. The mode for the user to input only the private information is also provided. The data obtained from the acquired information are classified in a step S9, based on the definition, and are stored in the database 53 in a step S110.

By the above processing, the experience information and the private information of the user are put into order and stored in the database 53 in such a manner as to permit facilitated retrieval.

The case of exploiting the user's private information, registered in the information registration unit 10, is now explained with reference to FIGS. 2 and 5. Although data are entered only in portions necessary for the explanation, it is to be understood that other data are included in the void columns. Here, the case of the user retrieving the information pertinent to restaurants is explained.

With the private information management apparatus 1, it is specified in a step S11 whether or not a terminal, forming the basis of information retrieval, is to be selected from another user terminal. If the terminal A is satisfactory, the private information management apparatus 1 acquires the position information of the current site or the other information by a method similar to the method used in the information registration phase. Then, in a step S14, it is determined whether or not the retrieving condition has been entered. In case the retrieving condition is entered form the user, a keyword is extracted, depending on the inputting method. For inputting the retrieving condition, a keyword included in the information corresponding to the current state of the user, as acquired by the private information management apparatus itself, may automatically be selected as a retrieving key, or the condition directly entered by the user may additionally be used. The inputting method by the user may be enumerated by a method consisting in manual inputting, item by item, based on the GUI for entering the retrieving condition, a method consisting in entering the speech under a guidance, and a method consisting in simply uttering the keyword. In the following, the case in which the retrieving condition has been entered by speech from the user is explained.

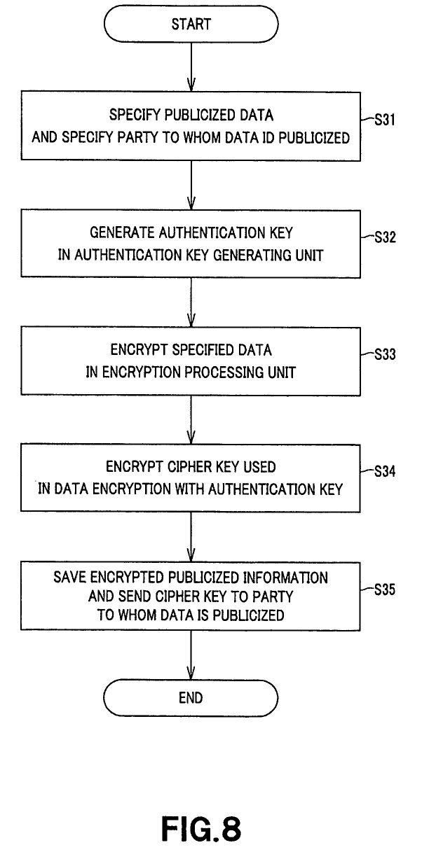

If, on the other hand, another user terminal is designated in the step S11, authentication processing, as later explained, is carried out in a step S13 between the private information management apparatus and the designated terminal. In order for the private information management apparatuses 1 (terminals A and B) to exchange the information with each other, it is necessary that the processing of providing the information that may be publicized responsive to a request from another terminal is carried out at the outset. FIG. 8 shows the processing for publicizing the information in the private information management apparatus 1.

In a step S31, data allowed to be publicized and a counterpart user for whom the data is publicized are designated. The data is the data defined by a data definition processing unit 52. In the next step S32, the authentication key generating unit 59 generates an authentication key and, in the next step S33, the encryption unit 60 encrypts the designated data. In the next step S34, the encryption key, used for data encryption, is encrypted by the authentication key generated in the step S32. The encrypted data is saved in the database 32 as the publicized information. The encrypted key is saved in a step S35 in the database 32 as the publicized information. The encryption key is sent to the terminal of the user authorized to have the information publicized.

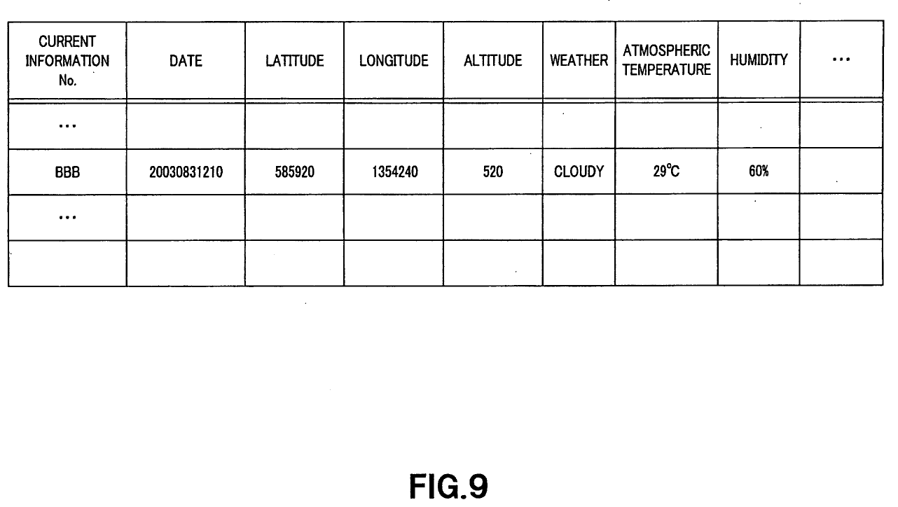

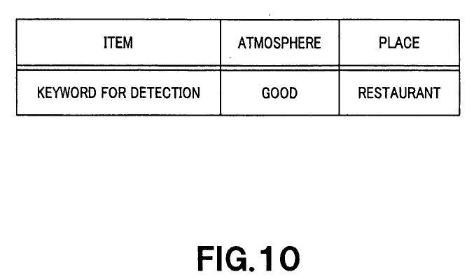

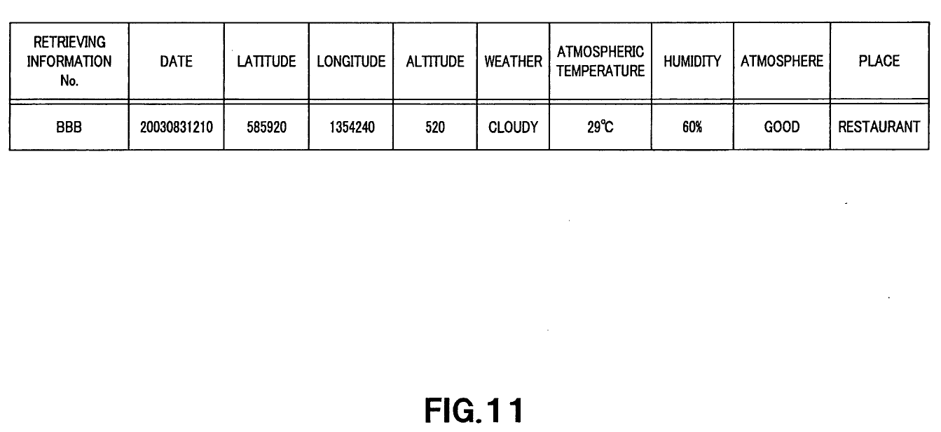

In case the user has uttered “restaurant with amicable atmosphere” to the private information management apparatus 1, the speech recognition unit 48 executes the speech recognition processing, and extracts the keywords “atmosphere”, “amicable” and “restaurant”. The private information management apparatus 1 in the step S12 acquires the position information of the current site, or the other information, by a method similar to one used in the information registration phase. The position information of the current site, acquired at this time, and the other information, are referred to below as the current information. FIGS. 9 and 10 show the current information acquired in the step S12 and the retrieval condition entered by the user, respectively. In association with the numbers of the acquired information, the time information for Aug. 31, 2003, 12:10 is represented as “200308311210”, while the position information is registered as “585920, 1354240, 520” (58°59′20″ latitude, 135°42′40″ longitude and 520 m altitude). In addition, the information pertinent to the attendant circumstances, such as the weather information, transmitted from the base station, for example, is acquired. The retrieval conditions, acquired by the private information management apparatus 1, are “good” atmosphere and name of the place being the “restaurant”, as shown in FIG. 10. Thus, these data are added to data used as the retrieval condition, such that the set of data shown in FIG. 11, including these data, becomes a keyword for the retrieval conditions.

The experience information, acquired in the step S12, is recognized and processed in the processing of a step S15 and in the following steps. In case the information acquired is the image data, image recognition processing is carried out on image data acquired from a CCD camera 42 in a step S15. If the information acquired is image data and the letter/character information, the sentence recognition unit 47 in a step S16 executes the text recognition processing on the image data acquired from the CCD camera 42. For example, the sentence recognition unit 47 executes the text recognition processing on image data acquired from the CCD camera 42, and recognizes the letter/character string or the symbol in the image, such as letters/characters in a placard, to extract the name of the building or the sign as text data. If the information is speech data, the speech recognition processing unit 40 in a step S17 performs speech recognition processing on the acquired speech data. In the next step S18, the language processing unit 50 converts the speech information into text data and, in the next step S18, the keyword extraction unit 51 extracts the keyword from the text data. If the information is text data or GPS data, processing transfers directly to the next step. If no retrieval condition has been entered in the step S114 from the user, processing similarly transfers directly to the step S20.

In the step S20, the information including the retrieval conditions and the information analogous with the retrieval conditions are extracted from the database 53, based on the current information extracted in the steps S12 to S19 and the retrieving condition entered by the user. For extracting the information retrieved from the database by the user, the database management system used in the information registration unit 10 is used. For example, memory base reasoning (MBR), the distance between two points (Euclid distance) and so forth, are used. As for the retrieving method, if such a case is found in which all items of the information stored in the database are available, the evaluation values for the experience entered by the user are prioritized, whereas, if the totality of the items are not available, priority is placed on the items with a higher degree of matching. The information of other experiences of evaluation values, specified by the retrieving conditions, as input by the user, may also be retrieved.

If, in the step S21, there is no information including the retrieving conditions in the database 53, nor the information analogous with the retrieving condition, processing reverts to the step S11. The information extracted by the data definition processing unit 52, as the retrieving unit, is presented in a step S22 to the user, by text data, speech guide, image display or by the combination thereof (arrow E in FIG. 2.

If the retrieving condition has been input by the user in the step S12, retrieval is carried out based on the keyword of the retrieving condition. If the retrieving condition has not been input, retrieval is carried out under a condition analogous to the current information. For example, if the current place is the restaurant, and the user visited this restaurant in the past, the result of evaluation at such past time is displayed. If the user did not visit this restaurant in the past, the information on a near-by restaurant the user visited in the past is presented. If no retrieving condition has been entered, but the current time is the meal time, the information on the restaurant near the user's current site is presented.

The acquisition of the information from another user terminal may also be carried out independently of the information retrieval. That is, retrieval may be carried out by specifying the experience information and the private information of the user B from the outset. In addition, the own experience information and the private information of the user B may be specified from the outset for retrieval, or the experience information and the private information of user and those of the user B may also be used for retrieval.

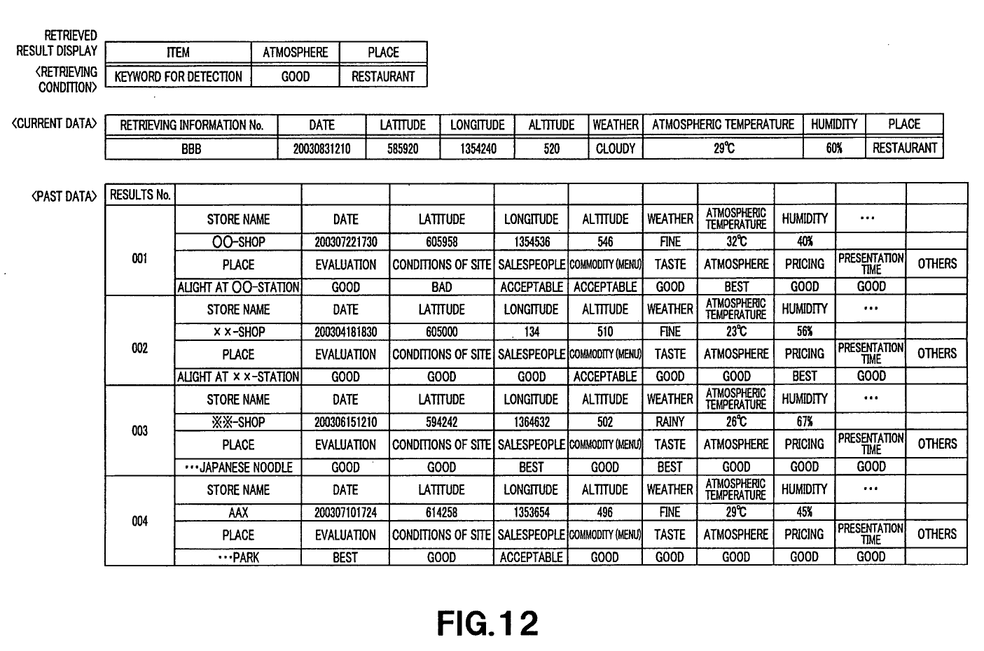

A data example, displayed as being the result of retrieval, is shown in FIG. 12. Retrieved results 001, 002, 003 and 004 are displayed against the input current information and retrieving conditions. Of these past data, the retrieved results 001, 002 and 003 are the information experienced by the user, while the retrieved result 004 is the result obtained from the terminal B. As for the display order, the contents of the retrieving conditions by the user are given the priority. For example, if the user has entered “near”, priority is placed on being “near” to the current site, rather than on the high information evaluation.

Moreover, in this technique, data stated in the schedule management software may be used. For example, if the user is scheduled to visit a certain place at a certain time on a certain date, and this schedule is registered in the schedule management software, it is possible to extract the optimum route from the database 53 and the start target time, from the database 53, for presentation to the user in advance. Moreover, in the above example, the selective operation in the step S11 may be carried out on the basis of speech recognition of the uttered information, such as “Retrieved from data of Mr. So and So”.

Thus, the present private information management apparatus 1, as described above, is able to store the information, experienced by the user, along with the information that may be reminiscent of the experience for the user. Since the information obtained on retrieving the data storage unit of the present apparatus is the information once experienced by the user, the information obtained on retrieving the data storage unit by the present apparatus is efficacious and of high utility as compared to the information obtained by the technique of keyword retrieval on the network, such as the Internet. Moreover, the information reminds the user of the event he/she experienced in the past, and hence is more realistic than the generalized information obtained on retrieval on the network. In addition, the user specifies the information which is among the user's experience information or private information pertinent to an experienced event, and which he/she does not feel disinclined to publicize for other user(s), so that the user is able to exchange the information with previously authorized other user(s).

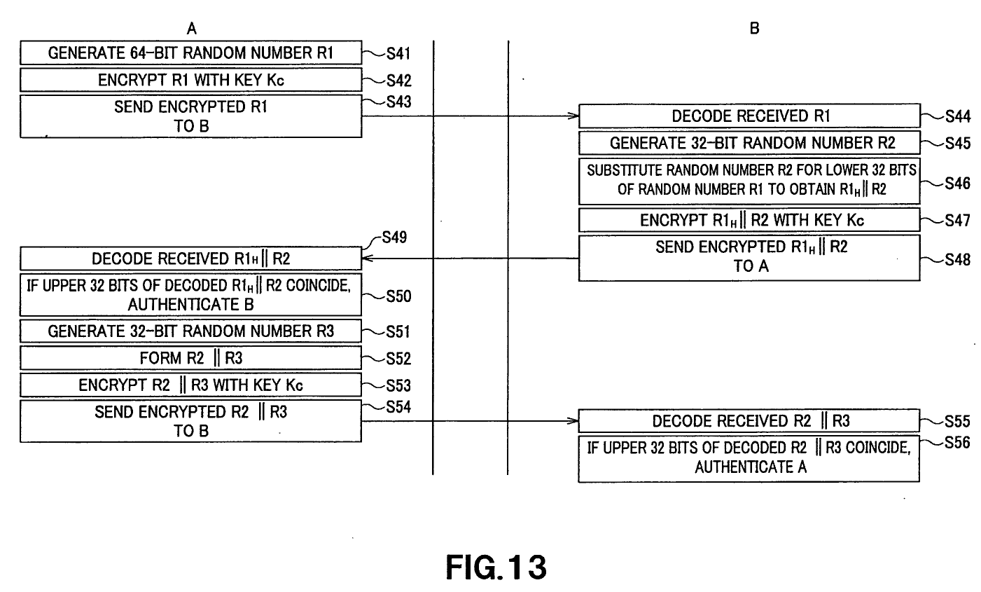

In the private information management apparatus 1 of the present concrete example, a method for authenticating other similar apparatuses, with which the information of the present apparatus 1 can be exchanged, is now explained with reference to FIGS. 13 to 15. For authentication, a public key system or a common key system may be used. As an example of the common key system, the DES (data encryption standard) is an encryption system which uses a 56-bit common key and which processes 64 bits of the plaintext as one block. The DES processing is made up by a data scramble part, scrambling the plaintext to convert it into a cryptotext, and a key processing part, generating a key used in the data scramble part (enlarge key) from the common key. Since all of the algorithms of the DES are disclosed, the basic processing of the data scramble part is here explained only briefly.

First, the 64 bits of the plaintext are divided into H₀ of upper 32 bits and L₀ of lower 32 bits. An output of an F function, in which a 48-bit enlarge key K₁, supplied from the key processing unit, and L₀ of the lower 32 bits, are input, and L₀ of the lower 32 bits is scrambled, is calculated. The F function is made up by two sorts of basic transformation, namely ‘substitution’ of replacing the numbers by a preset rule, and ‘transposition’ of replacing bit positions in accordance with a preset rule. The H₀ of the upper 32 bits and an output of the F function are then Ex-ORed to give a result L₁. L₀ is set to H₁.

Based on H₀ of the upper 32 bits and on L₀ of the lower 32 bits, the above processing is carried out 16 times, so that H₁₆ of the upper 32 bits and L₁₆ of the lower 32 bits are output as a cryptotext. For decryption, the above-described sequence of operations is traced in the reverse direction, using the common key used for encryption.

The signature is appended to data or a certificate as later explained for use in checking the falsification or authenticating the formulator. The signature is formulated by taking a hash value with a hash function, based on data desired to be transmitted, and encrypting the hash value with the secret key of the public key cryptosystem.

The hash function and the signature collation are explained. The hash function is a function which has preset transmitted data as input and which compresses the input data into data of a preset bit length to output the compressed data as a Hash value. The Hash function is featured by the fact that an input is difficult to predict from the hash value (output), many bits of the Hash value are changed when a single bit of data input to the Hash function is changed, and that input data having the same Hash value are difficult to search.

A recipient, who has received the signature and data, decrypts the signature with the public key of the public-key cryptosystem, to obtain the result (hash value). The hash value of the received data is calculated. It is then verified whether or not the hash value calculated is equal to the hash value obtained on decoding the signature. If it is verified that the hash value of the transmitted data is equal to the decoded hash value, it may be seen that the received data has not been falsified, such that data is that sent from a transmitting party holding a secret key corresponding to the public key. As the hash function for the signature, MD4, MD5 or SHA-1, may be used.

The public key cryptosystem is now explained. In contradistinction from the common key encryption system, the public key encryption system uses a key for encryption differing from a key for decryption. In case of using the public key encryption system, even if one of the keys is publicized, the other may be kept confidential. The key that may be publicized is termed a public key, while the other key, that is to be kept confidential, is termed a secret key.

The RSA (Rivest-Shamir-Adleman) cryptosystem, as typical of the public key cryptosystem, is now explained. Two sufficiently large prime numbers p, q are found, and n, which is a product of p and q, is found. The least common multiple L of (p−1) and (q−1) is calculated, and three or more numbers e lesser than L and coprime with respect to L are found. That is, there is only one number with which e and L may be divided out in common.

The multiplication inverse element of e pertinent to multiplication with L as a modulus is then found. That is, the relationship: ed=1 mod L holds between d, e and L, where d may be found by Euclid's algorithm for finding the least common multiple. In this case, n and e are public keys and p, q and d are secret keys.

The cryptotext C may be calculated from the plaintext M by the processing of the equation (1) and may be decrypted to the plaintext M by the processing of the equation (2):
C=M\hat{ }e mod n (1)
M=C\hat{ }d mod n (2).

Although the proof is not given here, it is based on the Felmat's little theorem, that is, on the fact that the equation (3) holds, that the plaintext may be converted by RSA cryptography into cryptotext and decrypted:
M=C\hat{ }d=(M\hat{ }e)\hat{ }d=M\hat{ }(ed)mod n (3).

If the secret key p, q are known, the secret key d can be computed from the public key e. However, if the number of digits of the public key n is enlarged to such an extent that factorization of the public key n is difficult in view of the computational volume, the secret key d cannot be calculated form the public key e even if the public key n is known, such that decoding is not possible. In the RSA cryptosystem, the key used for encryption may differ from that used for decryption.

The elliptical curve cryptosystem system, as another example of the public key cryptosystem, is now briefly explained. If a point on an elliptical curve y=\hat{ }2=x\hat{ }3+ax+b is B, addition of the points on the elliptical curve is such that the result of addition of B n times is defined as nB. In similar manner, subtraction is defined. It has been proved that n is difficult to calculate from B and nB. B and nB are public keys and n is a secret key. With use of a random number r, the cryptotexts C1 and C2 may be calculated from the plaintext M by the processing of the equations (4) and (5), using the public key:
C1=M+rnB (4)
C2=rB (5)

The cryptotexts C1 and C2 may be decrypted to the plaintext M by the processing of the equation (6):
M=C1−nC2 (6).

Only the text having the secret key n can be decrypted. Thus, with the use of the elliptical curve cryptosystem, the key for encryption may differ from that for decryption, as in the case of the RSA cryptosystem.

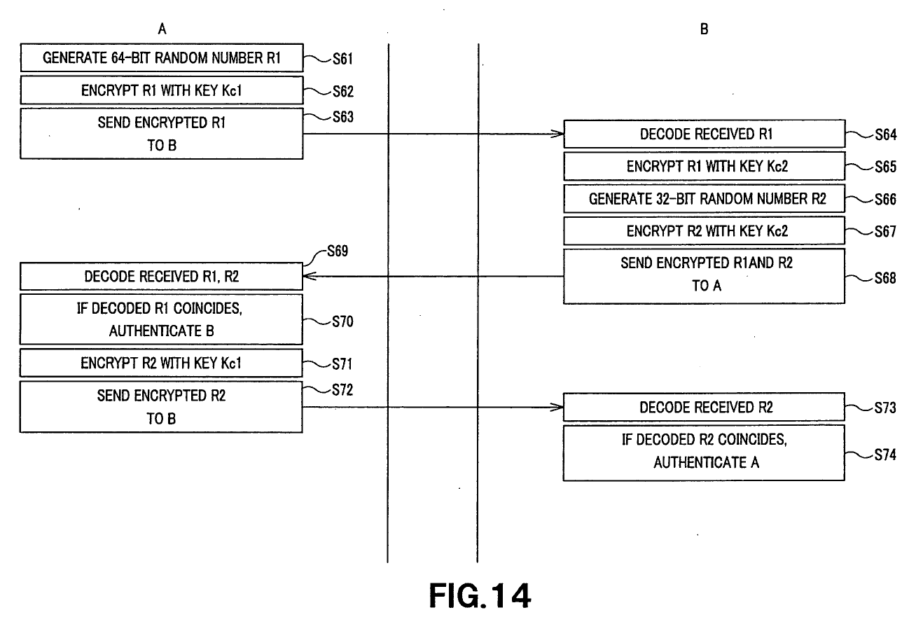

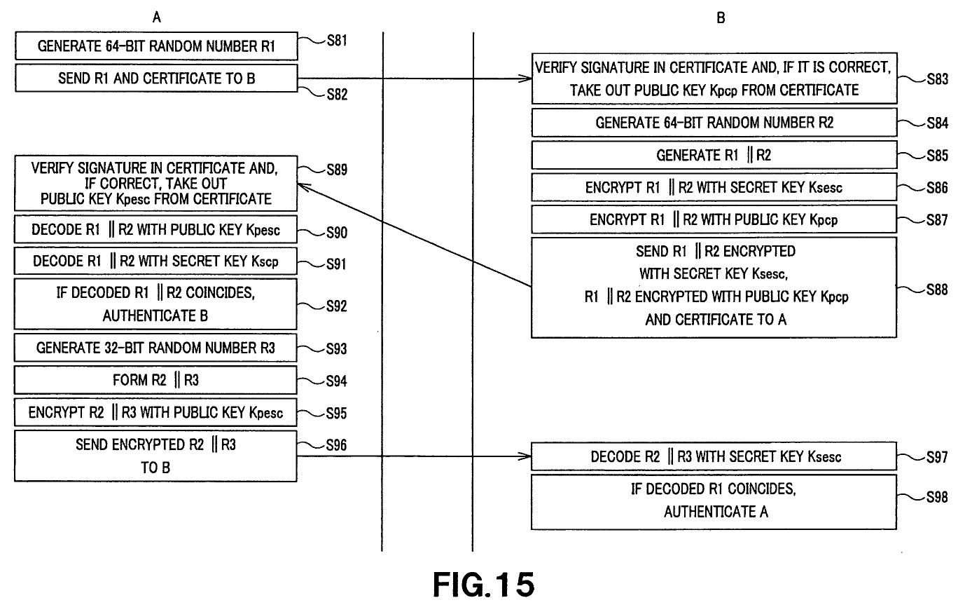

The processing of reciprocal authentication, for confirming that there is no so-called “impersonation”, is explained, taking FIG. 13, employing a common key, FIG. 14, employing two common keys, and FIG. 15, employing a public key cryptotext, as examples. FIG. 13 depicts a flowchart illustrating the operation for reciprocal authentication of an authentication processing unit of a terminal A and authentication processing unit of a terminal A, employing the DES as a common key cryptosystem, with the use of a sole common key. In a step S41, an authentication processing unit of the terminal A generates a 64-bit random number R1, which may also be generated by the random number generator 35. In a step S42, the authentication processing unit of the terminal A encrypts the random number R1 with the pre-stored common key Kc, using the DES. This encryption may be carried out by the encryption processing unit 60. In a step S43, the authentication processing unit of the terminal A sends the encrypted random number R1 to the authentication processing unit of the terminal B.

In the step S44, the authentication processing unit of the terminal B decrypts the received random number R1 with the pre-stored common key Kc. In a step S45, the authentication processing unit of the terminal B generates a 32-bit random number R2. In a step S46, the authentication processing unit of the terminal B substitutes a random number R2 for lower 32 bits of the random number R1, formed by decoded 64 bits, to generate a concatenation R1_{H}∥R2, where R1_{H} denotes upper bits of R1 and A∥B denotes concatenation of A and B (m-bit B is linked to the lower side of n-bit A to give (n+m) bits). In a step S47, the authentication processing unit of the terminal B encrypts the R1_{H}∥R2, with the common key Kc, using the DES. In a step S48, the authentication processing unit of the terminal B transmits the encrypted R1_{H}∥R2 to the terminal A.

In a step S49, the authentication processing unit of the terminal A decodes the received R1_{H}∥R2, using the common key Kc. In a step S50, the authentication processing unit of the terminal A checks for the upper 32 bits of the R1_{H} of the decoded R1_{H}∥R2 to verify that the terminal B is authentic if these upper 32 bits coincide with the upper 32 bits R1_{H} of the random number R1 generated in the step S41. If the generated random number R1 is not coincident with the received R1, processing comes to a close. If these coincide, the authentication processing unit of the terminal A in a step S51 generates a 32-bit random number R3. In a step S52, the authentication processing unit of the terminal A sets the received and decoded random number R2 in an upper order part, while setting the generated random number R3 in the lower order part to give the concatenation R2∥R3. In a step S53, the authentication processing unit of the terminal A encrypts the concatenation R2 ∥R3, using the common key Kc by the DES. In a step S54, the authentication processing unit of the terminal A transmits the encrypted the concatenation R2 ∥R3, to the authentication processing unit of the terminal B.

In a step S55, the authentication processing unit of the terminal B decodes the received concatenation R2∥R3 with the common key Kc. In a step S56, the authentication processing unit of the terminal B checks for the upper 32 bits of the decoded concatenation R2∥R3 and, if these coincide with the random number R2, the authentication processing unit of the terminal B verifies the terminal A as the authentic counterpart of communication. If otherwise, the authentication processing unit of the terminal B deems the terminal as an unjust counterpart of communication to terminate the processing.

FIG. 14 depicts a flowchart for illustrating the operation of reciprocal authentication of the authentication processing unit of the terminal A and the authentication processing unit of the terminal B, employing the DES (Data Encryption Standard), with two common keys being Kc1, Kc2. In a step S61, the authentication processing unit of the terminal A generates a 64-bit random number R1. In a step S62, the authentication processing unit of the terminal A encrypts the random number R1 with a pre-stored common key Kc1, using DES. In a step S63, the authentication processing unit of the terminal A transmits the encrypted random, number R1 to the terminal B.

In a step S64, the authentication processing unit of the terminal B decodes the random number received R1 with the pre-stored common key Kc1. In a step S65, the authentication processing unit of the terminal B encrypts the random number R1 with the pre-stored common key Kc2. In a step S66, the authentication processing unit of the terminal B generates a 64-bit random number R2. In a step S67, the authentication processing unit of the terminal B encrypts the random number R2 with the common key Kc2. In a step S68, the authentication processing unit of the terminal B sends the encrypted random numbers R1 and R2 to the authentication processing unit of the terminal A.

In a step S69, the authentication processing unit of the terminal A decodes the received random numbers R1 and R2 with the pre-stored common key Kc2. In a step S70, the authentication processing unit of the terminal A checks for the decoded random number R1 and, if this decoded random number coincides with the random number R1, generated in the step S61 (pre-encryption random number R1), the authentication processing unit of the terminal A verifies the terminal B as the authentic counterpart of communication. If otherwise, the authentication processing unit of the terminal A deems the terminal as an unjust counterpart of communication to terminate the processing. In a step S71, the authentication processing unit of the terminal A encrypts the random number R2, obtained on decoding, with the common key Kc1. In a step S72, the authentication processing unit of the terminal A encrypts the random number R2, obtained on decoding, with the common key Kc1. In a step S72, the authentication processing unit of the terminal A transmits the encrypted random number R2 to the terminal B.

In a step S73, the authentication processing unit of the terminal B decodes the received random number R2 with the common key Kc1. If, in a step S74, the decoded random number R2 coincides with the random number R2, generated in the step S66 (pre-encryption random number R2), the authentication processing unit of the terminal B verifies the terminal A as the authentic counterpart of communication. If otherwise, the authentication processing unit of the terminal B deems the terminal A as an unjust counterpart of communication to terminate the processing.

FIG. 15 depicts a flowchart illustrating the operation of reciprocal authentication of the authentication processing unit of the terminal A and the authentication processing unit of the terminal B employing a 160-bit long elliptical curve cipher as the public key cipher. In a step S81, the authentication processing unit of the terminal A sends a certificate including the own public key Kpcp, acquired at the outset from the authorization authorities, and the random number R1, to the authentication processing unit of the terminal B.

In a step S83, the authentication processing unit of the terminal B decodes the signature of the received certificate (encrypted by the secret key Ksca of the authorization authorities), to take out the public key Kpcp of the terminal A and the hash value of the name of the terminal A as well as the name of the terminal A. If the certificate is an authentic one, issued by the authorization authorities, the signature of the certificate can be decoded, while the public key Kpcp decoded and the hash value of the name of the terminal A coincide with the public key Kpcp of the terminal A stored as plaintext in the certificate and with the hash value obtained on applying the hash function to the name of the terminal A, respectively. This proves that the public key Kpcp is a just one not falsified. If the signature cannot be decoded, or if it could, the hash values are not coincident, the public key is not proper, or the counterpart of communication is not authentic. In such case, processing comes to a close.

If the proper results of authentication have been produced, the authentication processing unit of the terminal B in a step S84 generates a 63-bit random number R2. In a step S85, the authentication processing unit of the terminal B generates the concatenation R1∥R2 of the random numbers R1 and R2. In a step S86, the authentication processing unit of the terminal B encrypts the concatenation R1 ∥R2 with an own secret key Ksesc. In a step S87, the authentication processing unit of the terminal B encrypts the concatenation R1∥R2 with the public key Kpcp of the terminal A, acquired in the step S83. In a step S88, the authentication processing unit of the terminal B transmits the concatenation R1∥R2, encrypted with the secret key Ksesc, the concatenation R1∥R2, encrypted with the secret key Kpcp, and the certificate, including the own public key Kpesc, acquired in advance from the authentication authorities, to the authentication processing unit of the terminal A.

In a step S89, the authentication processing unit of the terminal A decodes the signature of the received certificate, with the public key Kpca of the authentication authorities, acquired at the outset. If the signature is correct, the authentication processing unit of the terminal A takes out the public key Kpesc from the certificate. The processing in this case is similar to that in the step S83 and hence is not explained specifically. The authentication processing unit of the terminal A then in a step S90 decodes the concatenation R1∥R2, encrypted with the secret key Ksesc of the terminal B, with the public key Kpesc, acquired in the step S89. In a step S91, the authentication processing unit of the terminal A decodes the concatenation R1∥R2, encrypted with the own public key Kpcp, with the own public key Kscp. In a step S92, the authentication processing unit of the terminal A compares the concatenation R1∥R2, decoded in the step S90, to the concatenation R1∥R2, decoded in the step S91. If the two coincide with each other, the authentication processing unit of the terminal A verifies the terminal B as the proper counterpart of communication and, if otherwise, the authentication processing unit of the terminal A verifies the terminal B as being not proper to terminate the processing.

If the result of authentication is satisfactory, the authentication processing unit of the terminal A in a step S93 generates a 4-bit random number R3. In the next step S94, the authentication processing unit of the terminal A generates the random number R2, acquired in the step S90, and a concatenation R2∥R3 of the random number R2 acquired in the step S90 and the generated random number R3. In a step S95, the authentication processing unit of the terminal A encrypts the concatenation R2∥R3 with the public key Kpesc, acquired in the step S89. In a step S96, the authentication processing unit of the terminal A transmits the so encrypted concatenation R2∥R3 to the authentication processing unit of the terminal B.

In a step S97, the authentication processing unit of the terminal B decodes the encrypted concatenation R2∥R3 with the own secret key Ksesc. If, in a step S98, the decoded random number R2 coincides with the random number R2 generated in the step S84 (random number R2 prior to encryption), the authentication processing unit of the terminal B verifies the terminal A as an authentic counterpart of communication and, if otherwise, the authentication processing unit of the terminal B verifies the terminal A as being not proper to terminate the processing.

The authentication processing unit of the terminal B and the authentication processing unit of the terminal authenticate each other, as described above. The random number used in the reciprocal authentication is used as a temporary key Ktemp effective only for the processing next following this reciprocal authentication.

1. A private information management apparatus comprising:
information acquisition means for acquiring experience information pertinent to an event experienced by a user;
private information adding means for adding to said acquired experience information the private information privately requested by the user;
storage means for putting said experience information and said private information into order and for storing the information so put into order in a manner which enables retrieval;
key generating means for generating an authentication key;
data encrypting means for encrypting part of the experience information and the private information stored in said storage means, based on an encryption key, wherein said encrypted information is publicized information; and
communication controlling means for transmitting the publicized information to an external device;
wherein said communication controlling means transmits the publicized information to a designated external device when an authentication key received from outside has been authenticated as being from said designated external device.

2. The private information management apparatus according to claim 1 further comprising:
operation inputting means for specifying information which is stored in said storage means and which is to be publicized, and an electronic device to which the information is to be publicized; and
wherein said data encrypting means encrypts the publicized information specified by said operation inputting means based on said encryption key.

3. The private information management apparatus according to claim 1 wherein said information acquisition means comprises speech data acquisition means for acquiring external speech data and includes speech recognition means for recognizing an utterance of a feature word from the external speech data; and
wherein said storage means puts into order and stores a result of recognition by said speech recognition means and the private information in a manner which enables retrieval.

4. The private information management apparatus according to claim 1 wherein said information acquisition means comprises image data acquisition means for acquiring external image data and includes image recognition means for recognizing a feature image from the external image data; and
wherein said storage means puts into order and stores a result of recognition by said image recognition means and the private information in a manner which enables retrieval.

5. The private information management apparatus according to claim 1 wherein said information acquisition means comprises sentence data acquisition means for acquiring sentence data and includes sentence recognition means for extracting feature words from the sentence data; and
wherein said storage means puts into order and stores a result of recognition by said sentence recognition means and the private information in a manner which enables retrieval.

6. A private information management method comprising:
acquiring experience information pertinent to an event experienced by a user;
adding to said experience information private information privately required by the user;
putting said experience information and the private information retrievably into order for storage;
encrypting part of the experience information and the private information, based on an encryption key, wherein resulting encrypted information is publicized information;
encrypting said encryption key by an authentication key; and
transmitting the publicized information to an external device; and
transmitting the publicized information to a designated external device when an authentication key received from outside has been authenticated as being from said designated external device.
